(19) United States
(12) Patent Application Publication
(10) Pub. No.: US 2015/0167916 A1
(43) Pub. Date: Jun. 18, 2015

(54) SHIELD APPARATUS FOR HEAD LAMP

(71) Applicant: Hyundai Motor Company, Seoul (KR)

(72) Inventor: Seong-Hoon Lee, Hwaseong-si (KR)

(73) Assignee: Hyundai Motor Company, Seoul (KR)

(21) Appl. No.: 14/276,588

(22) Filed: May 13, 2014

(30) Foreign Application Priority Data
Dec. 18, 2013 (KR) 10-2013-0158785

(51) Int. Cl. F21S 8/10

(52) U.S. Cl. CPC F21S 48/1784; F21S 48/125

(57) ABSTRACT

A shield apparatus for a head lamp may include a shield with a plurality of divided shields each having a rotating shaft and an actuator providing power to rotate the plurality of divided shields. The plurality of divided shields may be disposed on a shield body one above the other and may be rotatably coupled to each other via the rotating shafts. The plurality of divided shields may have vertical lengths that are gradually increased in a direction from an uppermost divided shield to a lowermost divided shield.

### CROSS REFERENCE TO RELATED APPLICATION

The present application claims priority of Korean Patent Application Number 10-2013-0158785 filed on Dec. 18, 2013, the entire contents of which application are incorporated herein for all purposes by this reference.

### BACKGROUND OF INVENTION

1. Field of Invention

The present invention relates, in general, to shield apparatuses for head lamps, and, more particularly, to a shield apparatus for a head lamp, which is capable of reducing operating noise and increasing light efficiency.

2. Description of Related Art

Generally, a head lamp provided on a vehicle secures the field of front vision for a driver, and is configured to selectively realize a low beam or a high beam. For this purpose, the head lamp includes a shield apparatus.

As shown in FIG. 1, a conventional shield apparatus for a head lamp includes a shield 1 that is rotatably installed to shield some of light emitted from a light source 3, and a drive part 2 that rotates the shield 1. In a closed state wherein the shield 1 stands up, the low beam is realized by light outputted from the light source 3. By contrast, in an open state wherein the shield 1 lays down, the high beam is realized.

However, the conventional shield 1 is problematic in that it is integrated into a single structure, so that it is large in size, and thereby operation is noisy and operational response is particularly slow.

In order to solve the problem, as shown in FIG. 2, a shield 11 divided into a plurality of shields has been proposed. As shown in the drawing, the conventional shield 11 divided into three shields is configured so that the shields have the same vertical length L1, and a cross-section of each shield 11 has the shape of a linear flat plate. This is problematic in that, when the shield 11 is in open state, among light outputted from the light source 12, much light is not radiated to a light distribution area 13 but is invalidated, and thereby light efficiency is reduced.

That is, when the shield 11 is in open state so as to realize the high beam, it is preferable that light outputted from the light source 12 be reflected by the shield 11 and then pass through a lens 14 to be radiated to the light distribution area 13 which is at a front position.

However, since the conventional divided shields have the same vertical length L1, most of light reflected through a lower end of a reflector housing 15 is not reflected by the shield 11 but is directly radiated to the outside of the lens 14 (see, arrow M1). Consequently, much light is not radiated to the light distribution area 13 but is invalidated, so that the light efficiency is reduced.

Further, the cross-sectional shape of the conventional divided shield 11 has the linear flat plate. Hence, in the case where the light of the light source 12 is reflected by an upper surface of the shield 11, the light is not radiated towards the lens 14 but is diffused upwards. Thereby, as the light is directly radiated to the outside of the lens 14 (see, arrow M2), much light is not radiated to the light distribution area 13 but is invalidated. As a result, light efficiency is reduced.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the related art and/or other problems, and the present invention is intended to provide a shield apparatus for a head lamp, in which a shield is divided into a plurality of shields and the amount of light that is not radiated to a light distribution area but is invalidated can be reduced, thus significantly increasing the amount of light that is radiated to the light distribution area through a lens, therefore increasing light efficiency and reducing operating noise.

Various aspects of the present invention provide for a shield apparatus for a head lamp that include a shield including a plurality of divided shields each having a rotating shaft, and an actuator providing power to rotate the plurality of divided shields, wherein the plurality of divided shields are disposed on a shield body one above the other and are rotatably coupled to each other via the rotating shafts, and the plurality of divided shields are formed such that vertical lengths thereof are gradually increased in a direction from an uppermost divided shield to a lowermost divided shield.

The divided shields may come into contact with each other, thereby preventing light from leaking between the divided shields when the divided shields are closed to realize a low beam. Each rotating shaft may disposed at an eccentric position that is lower than a middle point of a vertical length of a corresponding divided shield, thereby increasing a protruded amount of each divided shield from the rotating shaft towards a lens when the divided shields are open to realize a high beam.

An upper surface and a lower surface of each of the divided shields may be formed of arc-shaped curved surfaces protruding upwards to guide light outputted from a light source towards a lens, thereby decreasing invalidated light when the divided shields are open to realize the high beam. The arc-shaped curved surfaces of the upper and lower surfaces may be formed to have substantially a same curvature to stably radiate light from the light source.

When each of the divided shields rotates about the eccentrically coupled rotating shaft, each of the divided shields may rotate along an inner rotation trajectory and an outer rotation trajectory, wherein a radius of the inner rotation trajectory may be gradually increased in the direction from the uppermost divided shield to the lowermost divided shield to enhance light efficiency when the divided shields are open. A radius of the outer rotation trajectory may be gradually increased in the direction from the uppermost divided shield to the lowermost divided shield to enhance light efficiency when the divided shields are open.

As is apparent from the above description, the shield apparatus for the head lamp is advantageous in that the shield is divided into the plurality of shields or includes a plurality of divided shields, and the shields are formed such that their vertical lengths are gradually increased in the direction from the upper shield to the lower shield, and the upper surface and the lower surface of the shield are formed in the shape of a curved surface, thus significantly reducing the amount of invalidated light that is radiated to the outside of the lens when the shield is closed to realize a low beam and when the shield is open to realize a high beam, and thereby considerably increasing the light efficiency of the head lamp.

Further, the shield apparatus for the head lamp is advantageous in that the shield is divided into the plurality of shields, thus considerably reducing the operating noise, and enhancing response performance.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a conventional shield apparatus for a head lamp, in which a shield is comprised of one shield;

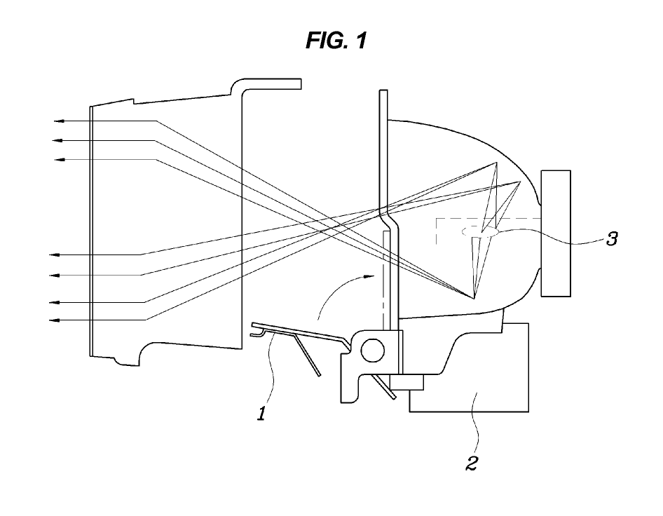

FIG. 2 is a view showing a conventional shield apparatus for a head lamp, in which a shield is divided into a plurality of shields;

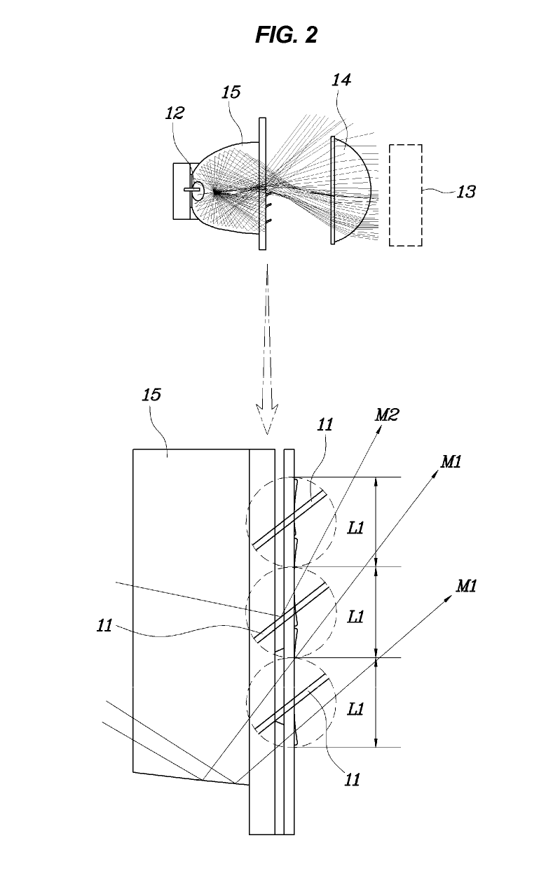

FIG. 3 is a view showing an exemplary shield apparatus for a head lamp according to the present invention, when the shield is closed;

FIG. 4 is an exploded perspective view of FIG. 3;

FIG. 5 is a view showing the shield apparatus, when the shield is open;

FIG. 6 is a sectional view taken along line I-I of FIG. 3;

FIG. 7 is a sectional view taken along line II-II of FIG. 5;

FIG. 8 is a view illustrating the shape of an exemplary shield according to the present invention; and

FIGS. 9 and 10 are views showing a light radiating path from a light source when the shield is closed and when the shield is open.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

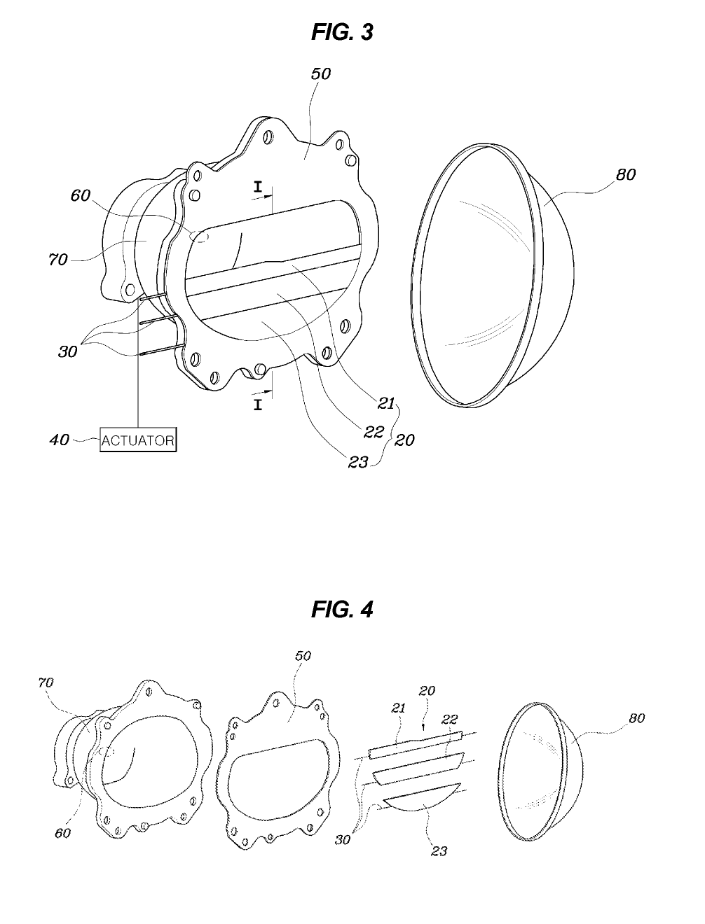

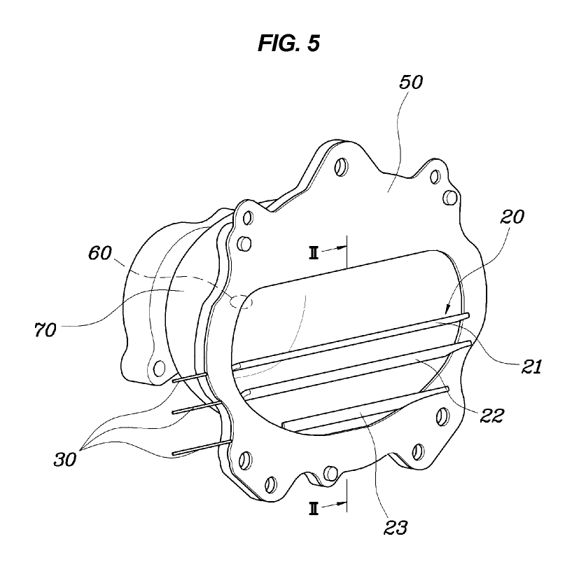

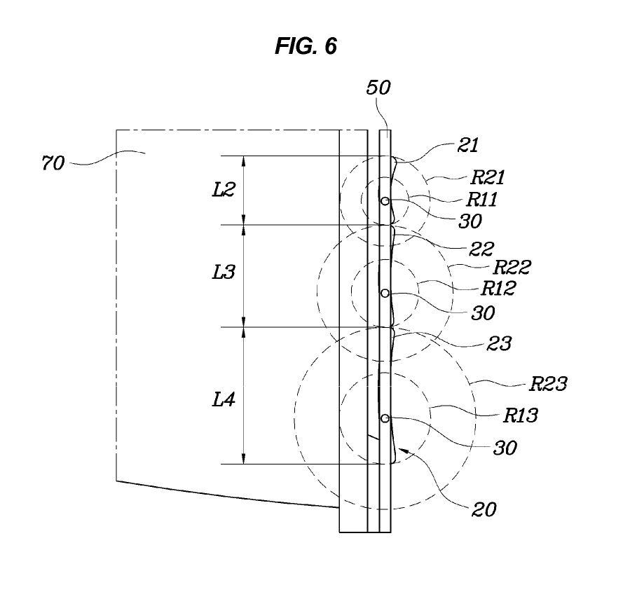

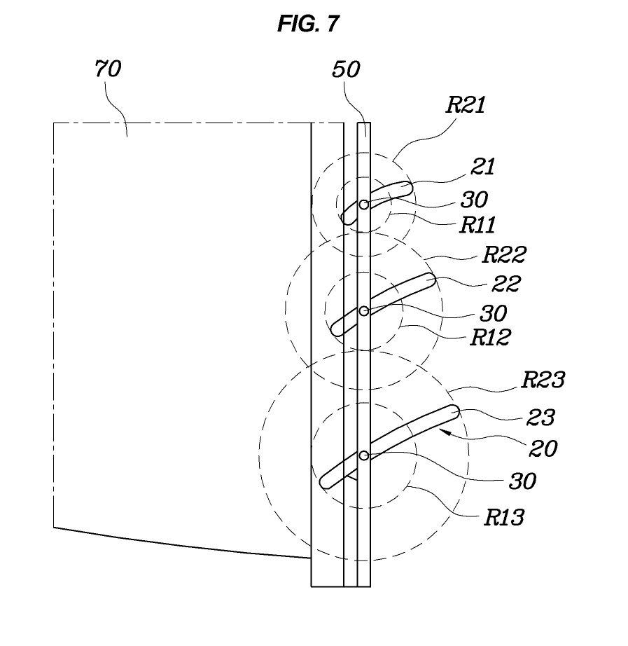

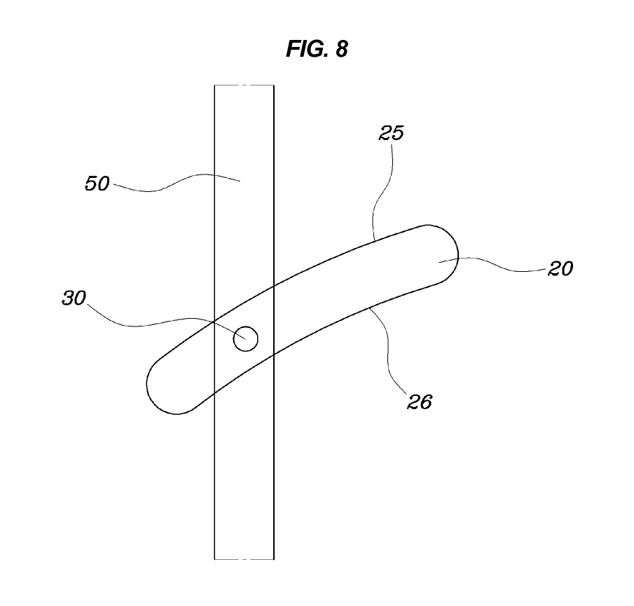

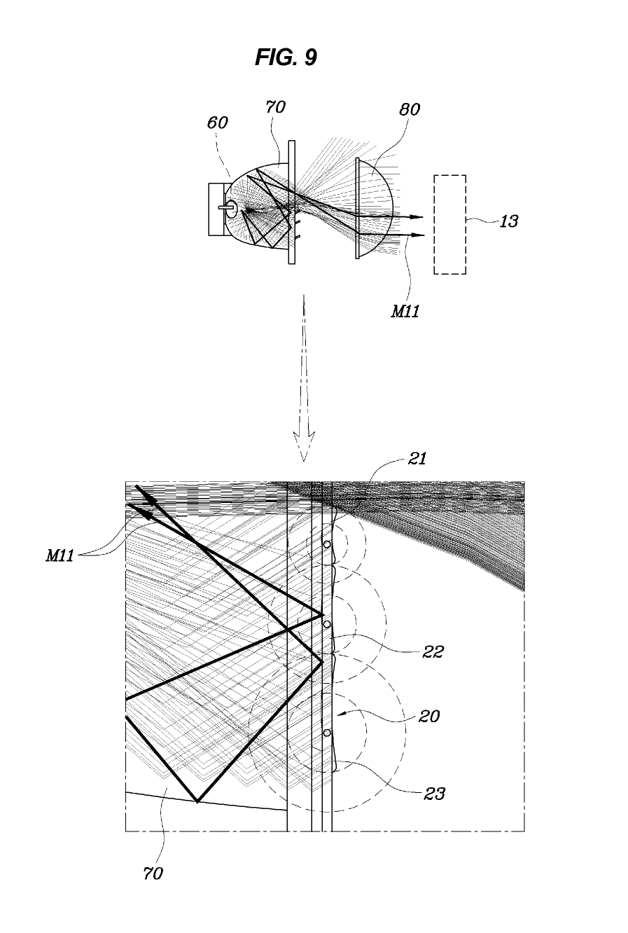

As shown in FIGS. 3 to 10, the shield apparatus for the head lamp according to the present invention includes a plurality of divided shields 20, a rotating shaft 30 provided on each of the shields 20, and an actuator 40 providing power to the rotating shaft 30 so as to rotate the shield 20.

According to various embodiments of this invention, the shields 20 may be composed of a first shield 21, a second shield 22, and a third shield 23, as one example. However, the present invention is not limited to the illustrated embodiments.

The shields 20 are disposed on a shield body 50 one above the other and are rotatably coupled to each other via the rotating shaft 30. The shield body 50 is fixedly coupled to a front surface of a reflector housing 70 to which a light source 60 is coupled. A lens 80 is disposed in front of the shields 20 to radiate light outputted from the light source 70 to a light distribution area 13.

According to the present invention, the plurality of shields 20 are formed such that vertical lengths L2, L3 and L4 thereof are gradually increased in the direction from the uppermost shield, namely, the first shield 21 to the lowermost shield, namely, the third shield 23. Such a configuration guides light outputted from the light source 60 towards the lens 80 and decreases invalidated light (or reduces loss of light) when the shields 20 are open to realize a high beam. Consequently, this can significantly increase light efficiency.

Further, in order to prevent light from leaking between the shields 20 when the shields 20 are closed to realize a low beam, the shields 20 come into contact with each other to prevent a gap from occurring.

That is, when the shields 20 are closed, the lower end of the first shield 21 comes into contact with the upper end of the second shield 22 to prevent a gap from occurring, the lower end of the second shield 22 comes into contact with the upper end of the third shield 23 to prevent a gap from occurring, and besides, the lower end of the third shield 23 comes into contact with the shield body 50 to prevent a gap from occurring. Such a configuration can prevent the leakage of light when the shields 20 are closed, thus significantly increasing light efficiency when the low beam is realized.

According to the present invention, a respective rotating shaft 30 is located at an eccentric position that is lower than a middle point of the corresponding vertical length L2, L3 or L4 of the shields 20. Such a configuration can increase the protruded amount of the shields 20 from the rotating shaft 30 towards the lens 80 when the shields 20 are open to realize the high beam. Consequently, this guides light outputted from the light source 60 towards the lens 80, thus reducing invalidated light and thereby considerably increasing light efficiency.

Further, according to the present invention, when the shields 20 are open to realize the high beam, an upper surface 25 and a lower surface 26 of each shield 20 are preferably formed in the shape of arc-shaped curved surfaces protruding upwards so as to guide light outputted from the light source 60 towards the lens 80 and thereby to decrease invalidated light. In particular, the arc-shaped curved surfaces of the upper and lower surfaces 25 and 26 are preferably formed in the same curvature to stably radiate light from the light source 60.

Further, when each shield 20 rotates about the rotating shaft 30 by the eccentrically coupled rotating shaft 30, the shields 20, that is, the first shield 21, the second shield 22, and the third shield 23 rotate along inner rotation trajectories R11, R12 and R13 and outer rotation trajectories R21, R22 and R23. In this case, the radii of the inner rotation trajectories R11, R12 and R13 are gradually increased in the direction from the uppermost shield, namely, the first shield 21, to the lowermost shield, namely, the third shield 23, thus enhancing light efficiency when the shields 20 are open.

Further, the radii of the outer rotation trajectories R21, R22 and R23 are gradually increased in the direction from the uppermost shield, namely, the first shield 21, to the lowermost shield, namely, the third shield 23, so as to enhance light efficiency when the shields 20 are open.

Hereinafter, the operation of the shield apparatus according to various embodiments will be described.

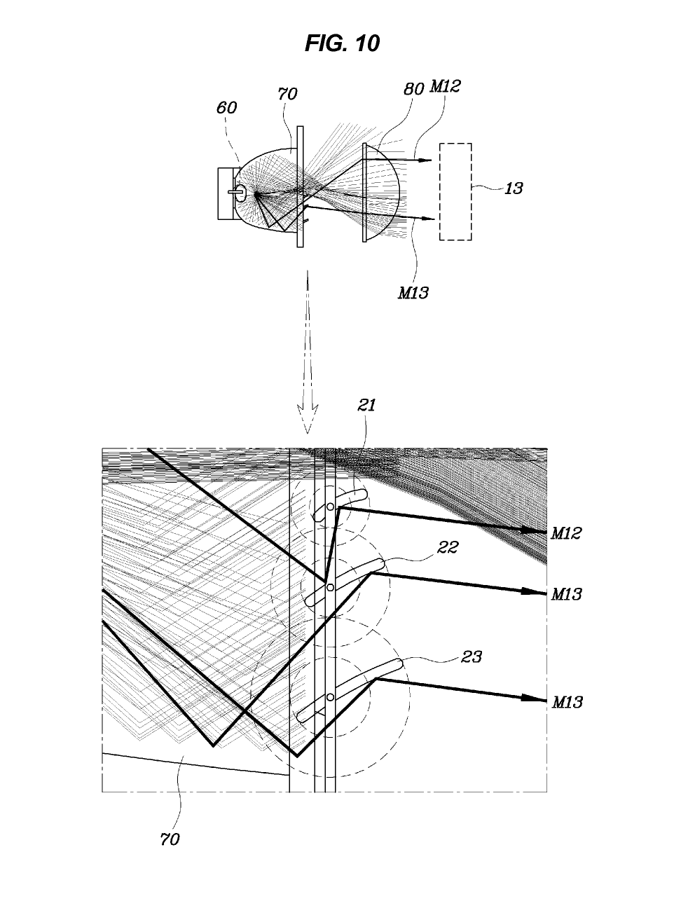

FIG. 9 shows the state where the shields 20 are closed to realize the low beam. Among the light outputted from the light source 60, light that does not come into contact with the shields 20 directly passes through the lens 80 and is radiated to the light distribution area 13 located at a front position.

Meanwhile, among the light outputted from the light source 60, light coming into contact with the shields 20 is reflected by the shields 20 and the reflector housing 70 and then passes through lens 80, thus being radiated to the light distribution area 13 located at the front position (see arrow M11).

As such, when the shields 20 are closed to realize a low beam, the lower end of the first shield 21 comes into contact with the upper end of the second shield 22 to prevent a gap from occurring, the lower end of the second shield 22 comes into contact with the upper end of the third shield 23 to prevent a gap from occurring, and besides, the lower end of the third shield 23 comes into contact with the shield body 50 to prevent a gap from occurring. Such a configuration can prevent the leakage of light when the shields 20 are closed, thus significantly increasing light efficiency when a low beam is realized.

FIG. 10 shows the state where the shields 20 are open to realize a high beam. Among the light outputted from the light source 60, light that does not come into contact with the shields 20 directly passes through the lens 80 and is radiated to the light distribution area 13 located at the front position.

Meanwhile, among the light outputted from the light source 60, light coming into contact with the shields 20 is reflected by the shields 20 and then passes through the lens 80, thus being radiated to the light distribution area 13 located at the front position (see arrow M12). Most of light reflected through the lower end of the reflector housing 70 is reflected by the shields 20 again and then passes through the lens 80, thus being radiated to the light distribution area 13 located at the front position (see arrow M13). As a result, the present invention enables light efficiency to be significantly increased.

In other words, the conventional divided shield has the cross-sectional shape of the linear flat plate. Thus, in the case where light from the light source is reflected by the upper surface of the shield, the light is not radiated towards the lens but is diffused upwards, so that it is directly radiated to the outside of the lens. Consequently, a much light is not radiated to the light distribution area but is invalidated, so that light efficiency is reduced.

In contrast, the shield 20 according to the present invention is formed such that its upper and lower surfaces 25 and 26 have the shape of the arc-shaped curved surfaces which are parallel or substantially parallel to each other, or have substantially the same curvature. Hence, if the light of the light source 60 reaches the upper surface 25 of the second shield 22, it is reflected to the lower surface 26 of the first shield 21 that is located above the second shield 22, and then is reflected towards the lens 80 through the lower surface 26 of the first shield 21 (see arrow M12). Thus, this can considerably reduce the amount of invalidated light that is not radiated towards the lens 80 but is diffused upwards. As a result, the light efficiency of the head lamp can be considerably increased.

Further, since the conventional divided shields have the same vertical length, most of the light reflected through the lower end of the reflector housing is not reflected by the shields again but is directly radiated to the outside of the lens. Thereby, much light is not radiated to the light distribution area but is invalidated. Consequently, the light efficiency is undesirably reduced.

However, the shields 20 according to the present invention are formed such that their vertical lengths L2, L3 and L4 are gradually increased in the direction from the first shield 21 which is at the upper position to the third shield 23 which is at the lower position. Hence, most of the light reflected through the lower end of the reflector housing 70 is reflected through the lower surface 26 of each shield 20 towards the lens 80 again (see arrow M13). This allows the amount of invalidated light radiated to the outside of the lens 80 to be considerably reduced, thus considerably increasing the light efficiency of the head lamp.

As described above, the present invention provides a shield apparatus for a head lamp, in which the shape of a plurality of divided shields is improved, thus considerably reducing the amount of invalidated light radiated to the outside of a lens both when the shields are closed to realize a low beam and when the shields are open to realize a high beam, thereby considerably increasing the light efficiency of the head lamp.

Further, the present invention provides a shield apparatus for a head lamp, in which shields are divided into a plurality of shields, namely, a first shield, a second shield, and a third shield, thus considerably reducing operating noise, and besides considerably improving the performance of response to operation.

For convenience in explanation and accurate definition in the appended claims, the terms “upper” or “lower”, “front” or “rear”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A shield apparatus for a head lamp, comprising:
a shield including a plurality of divided shields each having a rotating shaft; and
an actuator providing power to rotate the plurality of divided shields;
wherein the plurality of divided shields are disposed on a shield body one above the other and are rotatably coupled to each other via the rotating shafts; and
the plurality of divided shields are formed such that vertical lengths thereof are gradually increased in a direction from an uppermost divided shield to a lowermost divided shield.

2. The shield apparatus as set forth in claim 1, wherein the divided shields come into contact with each other, thereby preventing light from leaking between the divided shields when the divided shields are closed to realize a low beam.

3. The shield apparatus as set forth in claim 1, wherein each rotating shaft is disposed at an eccentric position that is lower than a middle point of a vertical length of a corresponding divided shield, thereby increasing a protruded amount of each divided shield from the rotating shaft towards a lens when the divided shields are open to realize a high beam.

4. The shield apparatus as set forth in claim 1, wherein an upper surface and a lower surface of each of the divided shields are formed of arc-shaped curved surfaces protruding upwards to guide light outputted from a light source towards a lens, thereby decreasing invalidated light when the divided shields are open to realize the high beam.

5. The shield apparatus as set forth in claim 4, wherein the arc-shaped curved surfaces of the upper and lower surfaces are formed to have substantially a same curvature to stably radiate light from the light source.

6. The shield apparatus as set forth in claim 3, wherein, when each of the divided shields rotates about the eccentrically coupled rotating shaft, each of the divided shields rotates along an inner rotation trajectory and an outer rotation trajectory,
wherein a radius of the inner rotation trajectory is gradually increased in the direction from the uppermost divided shield to the lowermost divided shield to enhance light efficiency when the divided shields are open.

7. The shield apparatus as set forth in claim 6, wherein a radius of the outer rotation trajectory is gradually increased in the direction from the uppermost divided shield to the lowermost divided shield to enhance light efficiency when the divided shields are open.
